(19) United States
(12) Patent Application Publication
(10) Pub. No.: US 2002/0165726 A1
(43) Pub. Date: Nov. 7, 2002

(54) System and method for facilitating creation and management of contractual relationships and corresponding contracts

(76) Inventor: Joseph A. Grundfest, Palo Alto, CA (US)

Correspondence Address: Erik B. Cherdak & Associates, LLC, 11300 Rockville Pike, Suite 906, Rockville, MD, 20852, US

(21) Appl. No.: 09/850,671

(22) Filed: May 7, 2001

(51) Int. Cl. G06F 17/60

(52) U.S. Cl. 705/1

(57) ABSTRACT

System and method for facilitating creation and management of contractual relationships and corresponding contracts online within an access controlled environment. The system and method include and involve a service facility configured to establish access controlled environments. The access controlled environments permit users to engage in secure online operations related to binding contracts between transaction parties. Also included and involved is a data storage facility that is coupled to the service facility and that permits users (transaction parties) to store and access data related to the binding contracts within the access controlled environments managed by and within the service facility. The data storage facility includes a master transaction agreement database and a contract database. The master transaction agreement database stores data related to master transaction agreements, and the contract database stores data related to contracts which are subordinate to at least one master transaction agreement. Master transaction agreements can contain terms and conditions regarding the enforceability (i.e., whether a contract is void, voidable, enforceable, etc.) of subordinate contracts.

### RELATED PATENT APPLICATIONS

The instant patent document is a continuation-in-part patent application of U.S. Pat. Application Ser. No. 09/XXX,XXX filed on Nov. 22, 2000, which application is entitled “SYSTEM AND METHOD FOR FACILITATING TRANSACTION PROCESSING AND DISPOSITION WITHIN AN ACCESS CONTROLLED ENVIRONMENT VIA A GLOBAL NETWORK SUCH AS THE INTERNET,” is pending before the U.S. Patent and Trademark Office, and is hereby incorporated by reference.

### BACKGROUND OF THE INVENTION

1. Field of the Invention

The present invention relates to the organization and management of contracts and contractual relationships. More particularly, it describes a method and process for assuring that all enforceable contracts involving a particular individual or entity are, or can be, consolidated within a single database, which database can be used in connection with a wide array of contract maintenance, knowledge management, and process management applications.

2. Description of the Relate Art

Individuals and enterprises are often parties to a large number of contracts. Large enterprises can be parties to many thousands or even millions of contracts. A retail chain store can, for example, be party to thousands of leases. A software manufacturer can be party to thousands of software licenses. A credit card company may be subject to millions of agreements with cardholders and merchants.

These contracts often exist in paper form and are stored at a wide number of locations. Even when those contracts exist in machine-readable form, they are often maintained in separate and incompatible databases. Under either circumstance, it is generally difficult or impossible efficiently to collect or become aware of all the terms and conditions in all the contracts binding an individual or enterprise.

The current state of the art thereby creates a wide range of problems and lost profit opportunities for enterprises. To cite but five examples, the absence of a centralized location at which an enterprise can be certain that all relevant, binding contracts can be found generates the following problems and lost profit opportunities:

First, the enterprise suffers potential financial losses because of an inability to recognize the full implications of contract expiration and renewal terms, among others. In particular, if a vendor can sequence all its contracts in an order of expiration, it can devote marketing and sales efforts to a highly rationalized program designed to assure contract renewals with is most valued customers. Because it is frequently more profitable to devote resources to maintaining existing contractual relationships than to developing or prospecting for new ones, the absence of a database that promotes contract retention can generate significant lost opportunities. Similarly, a lessee without access to a master, searchable database of its lease obligations can overlook, and therefore fail to exercise, valuable options to extend leases at favorable rates.

Second, the enterprise cannot track the implications of contractual terms that are dynamic in the sense that they can change over time. Consider, for example, the case of a contract that contains a most favored nation (MFN) clause. If a firm enters into Contract A that contains a most favored nation clause, and subsequently enters into Contract B which triggers Contract A's most favored nation clause, then the actual cost of Contract B will be higher than appears on the face of that document because of the cost of the concessions will have to be provided under Contract A's most favored nation clause. The absence of a centralized database thus prevents the enterprise from recognizing the full implications of entering into Contract B. Similarly, if contracts contain escalator or other price adjustment clauses, and if the enterprise has no efficient means of tracking such provisions, then it can overlook opportunities to increase prices and thereby to generate enhanced revenue pursuant to the terms of the existing contracts.

Third, the inability to search for trends or patterns in contract data can generate pockets of inefficiency in the enterprise. For example, a comparison of contracts across sales persons or across marketing groups might reveal that some sales persons or marketers are more effective at negotiating favorable terms beyond simple price and quantity. Given the ability to recognize such patterns, the enterprise might reward those sales persons and marketers more handsomely. It could also seek to educate others as to how to achieve more favorable contractual terms.

Fourth, the lack of assurances that all enforceable contractual obligations of a specified form reside in an identifiable database—whether machine-readable or not—creates significant audit and compliance risk. For example, if a sales person enters into a side agreement granting a purchaser the right to return certain goods, or if this side agreement otherwise materially modifies the contract, and if that side agreement is not disclosed to the enterprise's auditors, then the auditors may incorrectly recognize certain revenues. Upon subsequent discovery of these side agreements, the auditors may force the enterprise to restate its financials. Such restatements can cause significant stock price declines and substantial exposure to securities fraud litigation.

Fifth, the absence of such a comprehensive database can cause significant difficulties in maintaining compliance with corporate contracting polices. If, for example, an enterprise wishes to enforce a uniform dispute resolution clause that requires mandatory binding arbitration to be held in New York City pursuant to the rules of the American Arbitration Association, then absent a comprehensive database it cannot be assured of the desired compliance.

In an effort to address these problems, the current state of art relies on databases and spreadsheets that often are maintained by only one side to the contract. These databases are often incomplete inasmuch as binding contractual obligations can be omitted because of oversight, willful noncompliance, or a host of other reasons. Some on-line services also seek to capture the full text of agreements (see, e.g., www.dicarta.com) so as to facilitate a range of contract management, knowledge management, and process management functions. These services, however, also suffer the flaw that they cannot be assured of completeness in their databases. Put another way, even if a party expends substantial effort to build a contract database, it has no assurance that binding side-letters will not render the database materially inaccurate.

A further limitation of the current state of the art is that act of collecting the full text of agreements, or of populating databases with information about those agreements, can only identify situations in which there may have been non-compliance with corporate contracting procedures. The current state of the art cannot effect a cure for such lapses. For example, if a corporation has a policy calling for arbitration of all disputes in New York City, then even the most sophisticated full text search engines and knowledge extraction systems will only be able to identify contracts that are out of compliance. They cannot, in and of themselves, effect a cure to the problem.

Yet another limitation of the state of the current art is that the contract databases maintained by entities are typically “one-sided” in the sense that Party A may have a database that seeks to capture all of its contractual relationships, and Party B may have a database that seeks to capture all of its contractual relationships, but there is no assurance that Party A's view of its contracts with Party B are identical with Party B's view of its contracts with Party A. In practice, however, these two views of the underlying information regarding contracts between Parties A and B should be identical without regard to the perspective form in which the data are viewed.

It is additionally valuable and relevant to observe that certain publicly maintained databases seek to address portions of the problems described above, but do so in a manner that is subject to significant limitations. For example, publicly operated land title recordation offices are designed to provide notice to the public and to subsequent purchasers of property of claims, easements, liens, and other legal rights or obligations relating to a specified property. Similarly, Uniform Commercial Code (UCC) filings often are maintained in central repositories maintained by state agencies. These databases are, however, matters of public record and counterparties to contracts generally do not want to disclose private contractual relationships to public scrutiny. Further, these databases apply only to very specific forms of contractual rights and obligations, e.g., transactions involving real estate in a specific county, and do not seek or purport to provide a comprehensive catalogue of all contractual relationships involving a particular party.

It follows that the current state of the art lacks systems and methods for the creation of comprehensive and private databases in which persons can be confident that all binding contracts that comply with the parameters of the database's definition (including, possibly, all contracts binding the person) can be found, accessed and managed. Because of the absence of such comprehensive and private databases, the current state of the art also faces substantial limitations in its ability to apply a range of contracts, knowledge, and process management techniques.

The paragraphs that follow in conjunction with the drawing figures attached hereto illustrate the novel features and benefits of the present invention that squarely address the limitations of the prior art as discussed above.

### SUMMARY OF THE INVENTION

The present invention overcomes the limitations of the current state of the art as described above by creating a Master Transactions Agreement (“MTA”) between Party A and Party B, or any larger number of parties. The MTA contains a legally enforceable provision stating that any contract seeking to bind Party A in its relationship with Party B shall be void and/or voidable at the option of Party A unless the contract is contained within a specified database. The MTA can also optionally provide that omitted contracts are void or voidable at the option of Party B, or only with the mutual assent of Parties A and B.

Party A and Party B can then each maintain database instances of counterparties with which it has entered into MTAs (the “MTA Database”) as well as a database of contracts that are subject to the MTAs (the “Contract Database”). These databases can be maintained within a single database, or within multiple interconnected or interdependent databases and can be centrally located within a centrally accessible service facility.

The MTA can be defined with various degrees of inclusion. In its most expansive form, the MTA would apply to all contracts, past and future, between Parties A and B, without regard to the subject matter of the agreements. Such a broadly defined MTA could, however, generate many difficulties. For example, if an otherwise binding and effective contract was executed prior to the effective date of the MTA, and if, through oversight, the contract was inadvertently excluded from the database specified by the MTA, then the contract could be voided even though that was not the intention of the parties. Accordingly, some parties might find it desirable for the MTA to specify that it govern only contracts entered into after a specific date, or contracts that relate to specific forms of goods and services, such as real estate leases or software licenses, where the parties are sufficiently confident that they can attain completeness in their records.

The MTA can further be constructed to contain provisions that would expand the terms and conditions of contracts that are silent as to matters specified in the MTA. For example, the MTA can specify choice of law provisions, choice of forum provisions, arbitration provisions, notice provisions, etc. that would be effective if a contract that is subject to the MTA is silent as to any of those matters. Alternatively, the MTA can be structured so as to contain provisions that would apply notwithstanding the existence of provisions to the contrary in any other contract subject to the MTA. Such a mechanism would allow a party to assure compliance with an enterprise-wide contractual policy notwithstanding terms to the contrary that might be negotiated in any past and/or future negotiations relating to a specific contract.

The MTA can further provide for a “cure process” designed to address the potential invalidity of contracts that have inadvertently been omitted from the database. For example, in the event a contract has been omitted from the Contract Database the cure provisions of the MTA can provide for terms and conditions under which the contract can still be enforceable. Cure provisions may, for example, require concurrence of Party A's auditors that the contract is immaterial to Party A's financial situation and that recognition of the contract would not require any restatement or amendment to current or past financial statements.

The adoption of an MTA program, in order to be effective, would ideally, but not necessarily, be integrated with a variety of administrative and financial functions within the enterprise in order to assure that: (1) all counterparties who should be bound by MTAs are so bound; and (2) all contracts that should be submitted to the Contract Database are so submitted. For example, in order to assure that all suppliers and customers that should be subject to an MTA are so bound, an MTA program can be integrated with the corporation's accounts receivable and accounts payable functions in order to flag cash flows or other relationships with counterparties according to whether an MTA is in place. If cash flows are identified to or from entities that are not covered by MTAs, then corporate officers can inquire as to the nature of those flows and consider requiring that the counterparties enter into MTAs.

A desirable feature of the Contract Database that would be generated pursuant to the operation of the MTA is that it could be partially shared among the counterparties to the MTA. Thus, if the database contains all contractual relationships binding Party A with Party B as well as with many other counterparties, Party B could have access only to those contracts that bind Party B, while Party A can have access to the entire database. This shared access feature would allow both Parties A and B to have assurance as to the full nature of the agreements binding the parties, without providing inappropriate access to either counterparty. Indeed, such joint access could be viewed as an essential feature of the Contract Database because, absent joint access, Party B could have a concern that not all of the agreements binding it and Party A are properly stored in the Contract Database.

The existence of the MTA would also provide a valuable mechanism for assuring the integrity of the financial audit process. Audits can be called into question, and enterprises can be required to restate their financial statements in a manner that can lead to expensive litigation, because of the existence of side-letters that are concealed from auditors and that grant counterparties return rights, or specify other material terms that deviate from the body of the contract. If, however, an enterprise has an MTA with a counterparty then the possibility of an enforceable hidden side-letter is eliminated, at least with respect to the subject matter that is governed by the MTA. The quality of the audit process is thereby greatly enhanced.

Indeed, in certain situations, contracts may be subject to repudiation if they are not sufficiently apparent on the books and records of an enterprise. The operation of an effective MTA would eliminate such repudiation risks with respect to all matters required to be entered into the database.

The process of adopting and enforcing an MTA has further advantage because of the synergies and opportunities for cost sharing efficiencies that can be generated by such programs. Consider the example of Party A who contracts only with Parties B and C. Parties B and C in the example also contract with each other, as well as Parties D, E, F, G, etc. If Party A implements an MTA program with Parties B and C, then Parties B and C will be able to obtain a material portion of an MTA program's benefits through shared access to Party A's database even if they do not adopt an MTA program of their own. The marginal cost to Parties B and C of adopting a full MTA program would then be reduced by the fact that each of Party B and Party C would only have to add contracts between Parties B and C to complete a material portion of their own MTA database. Each of Parties B and C could then expand their database by adding contracts with other counterparties, D, E, F, G, etc. Accordingly, the use of an MTA generates significant potential economies of scale as a result of network effects that are inherent to contract relationships.

The efficiencies of such an arrangement are further enhanced if each party's MTA is maintained at a shared database site operated by a trusted third party where each contract would be entered once and where access would be strictly limited to the parties to each contract. Alternatively, each party can maintain its own distinct database and use a common trusted third party administrator to assure that contract databases are consistent across counterparties. In this situation, the trusted third party would assured that party A's database of contracts with Party B is identical with Party B's database of contracts with Party A.

A further and potentially distinct application of an MTA is to contracts that contain dynamic terms and conditions. A term or condition of a contract is considered dynamic for present purposes if its purpose or effect at some point in the future may differ from its purpose or effect at the time that the contract is entered into or becomes effective.

One common example of a dynamic term or condition is a “most favored nation” (MFN) clause. If a contract contains a MFN clause relating to the price at which a good will be sold, then the price that appears on the face of the contract may be subject to a substantial reduction because of a later contract that triggers the MFN clause.

A second example of a dynamic term or condition is a pricing formula that depends on future commodity prices, interest rates, or inflation rates.

In both examples substantial contract compliance issues can arise if there is no shared database involving the parties so that each individual agreement. In particular, in the case of a contract containing an MFN clause between Party A and Party B, unless Party B or a person acting on Party B's behalf, has access to all other contracts entered into by Party A relating to the subject matter of that contract, Party B will be unable to test or have any assurance that some later agreement between Parties A and C has not triggered a MFN obligation owed to Party B. Because Party A will have legitimate reason not to allow Party B to have access to all contracts that might relate to the MFN at issue, or to provisions in relevant contracts with third parties that are unrelated to the MFN, Parties A and B might agree to retain a trusted and independent third party to monitor and identify contracts entered into the Contract Database that might trigger the MFN obligation.

The case of a dynamically adjusted pricing formula raises a simple, though not insubstantial, contract management and compliance issue that can be addressed through the application of MTAs.

The databases generated by the MTA can also provide a valuable foundation for the application of a broad range of knowledge management and process management tools.

Given the existence of a Contract Database, a broad variety of knowledge management tools can be applied in order to extract additional value from that database for the enterprise. In particular, a variety of techniques, such as XML tagging and intelligent search, can be used to extract relevant data from the full text of the contracts entered into the database. The extracted information may, for example, relate to the expiration date of the agreement, the size of the contract, and the name of the counterparty. In many situations, however, the four corners of the contract (the entirety of a contract) will not contain all the information that a party would wish to know regarding the agreement. For example, the contract may have been negotiated by a particular marketing team, or may contain specific concessions that were offered for reasons not apparent on the face of the document. To capture this additional information, the Contract Database can be coupled with a series of additional questionnaires or other data entry tools designed to extract and collect valuable information not contained in the document.

The knowledge management system would then, for example, be able to search across financing agreements of all types to identify all relations that a Party might have with a specific bank or other counterparty. The accumulation of such information could provide valuable bargaining leverage across a range of transactions. The knowledge management system could also allow mangers to track the expiration date of contracts and to route expiring contracts by size or by the name or nature of the counterparty. This facility could enhance a sales departments' ability to cause renewal of particularly valuable contracts.

The existence of a Contract Database which may or may not be supplemented by information, not apparent on the four corners of the document, would also allow for the application of a broad range of process management tools. For example, on-line negotiation and electronic signatures can occur in the Contract Database itself, thereby assuring prompt compliance with the MTA and allowing management to track the progress of individual negotiations down to real time observation of the evaluation of specific terms. The Contract Database can be further expanded in this regard to allow for the retention of non-binding prior drafts of agreements to provide for an agreed-upon history of the negotiations, if the parties deem that desirable.

Accordingly, the present invention can be applied in many contexts and in many ways (e.g., for particular types of contracts such as real estate agreements, automobile leases, software licenses, etc.). For example, MTAs and subordinate contracts (for which data will be stored in the Contract Database) may be applied to agreements and contracts between parties entered into at specific times such as after specified dates, etc. Although data related to MTAs and subordinate contracts may be stored in central service facilities, transaction parties may also store corresponding data in their own systems such as within their data storage facilities, in their accounts receivables systems, in their accounts payable systems, etc.; centralized data can now be used to drive such user-specific systems.

MTAs and subordinate contracts contemplated by the present invention can specify any contracting term and condition. For example, such agreements may specify detailed business terms and standard, boilerplate terms and conditions such as choice of law provisions, notice provisions, etc. And, if individual subordinate contracts are silent of particular terms and conditions, reference (actual or implied) to controlling terms and conditions may now be achieved through review of a parent agreement or MTA.

And, since the present invention now permits transaction parties to engage in operations online relative to their contracts with other transaction parties, a host of additional services related to contracting may be instituted. For example, bid and offer systems may be used which incorporate form agreements which are subject to terms and conditions of one or more MTAs for which data now may be stored centrally.

As contracting practices may be carried out within a rules driven environment provided by the present invention (e.g., no subordinate contract until a proper MTA has been created, etc.), auditors and those reviewing contracts (parties, attorneys, courts, etc.) will be able to obtain greater and more efficient access to a party's contract affairs. Such access is achieved via the data management features of the present invention. As such, the data storage of contractual matters in accordance with the present invention now permits greater levels of contract compliance and integrity and, ultimately, will keep parties honest in their dealings with others.

And, since such contract matters are stored within a service facility which further facilitates controlled access environments in which parties can confidentially engage in contract and related management operations, transaction parties can be assured that there matters are securely and accurately stored, and accessed by authorized personnel only. Transaction parties can rest assured that their contract data integrity is maintained and that their contract related data as stored is what is purports to be.

To provide such functionality, and to deliver the benefits listed above, the present invention provides new systems and methods for facilitating creation and management of contractual relationships and corresponding contracts online within an access controlled environment. Such new systems and methods include and involve a service facility configured to establish access controlled environments. The access controlled environments permit users to engage in secure online operations relative to binding contracts. Also included and involved is a data storage facility that is coupled to the service facility that permits users to store and access data related to the binding contracts within the access controlled environments managed by and within the service facility. The data storage facility includes a master transaction agreement database and a contract database. The master transaction agreement database stores data related to master transaction agreements, and the contract database stores data related to contracts which are subordinate to at least one master transaction agreement.

### BRIEF DESCRIPTION OF THE DRAWING FIGURES

The present invention is described in detail below with reference to the attached drawing figures, of which:

FIG. 1 is a system diagram that illustrates a connected, network based data processing environment in which a service facility operates in accordance with a preferred embodiment of the present invention to facilitate creation and management of contractual relationships and corresponding contracts online within an access controlled environment provided by the service facility;

FIG. 2 is a block diagram of a typical automatic data processing system (e.g., computer system, etc.) that may be configured in accordance with the present invention to operate as the service facility, user systems and other external systems shown in FIG. 1;

FIG. 3A is a logical system diagram that illustrates the Master Transactions Agreement(s) (“MTAs”) and corresponding subordinate contracts that may be created and managed in accordance with a preferred embodiment of the present invention;

FIG. 3B is a schematic database diagram that illustrates the relationships that exist between an MTA and subordinate contractual relationships that are created and managed within access controlled environments in accordance with a preferred embodiment of the present invention;

FIG. 4 is a flowchart that illustrates the exemplary operations carried out within the system shown in FIG. 1 to facilitate creation and management of contractual relationships and corresponding contracts in accordance with a preferred embodiment of the present invention;

FIG. 5A is a detailed flowchart that illustrates the operations that are carried out to facilitate creation and management of contractual relationships and corresponding contracts in accordance with a preferred embodiment of the present invention;

FIG. 5B is a continuation flowchart of the flowchart started in FIG. 5A; and

FIG. 5C is the conclusion flowchart of the flowchart started in FIG. 5A.

### DETAILED DESCRIPTION OF THE PREFERRED EMBODIMENTS

The present invention is now discussed in detail with regard to the attached drawing figures which were briefly described above. Unless otherwise indicated, like parts and processes are referred to with like reference numerals.

### Definitions

In the context of the present invention, the following terms set off by quotation marks shall have the following meanings:

The term “Transaction” means any type of interaction between people which requires final resolution (disposition). For example, a contract is a transaction that requires the parties to the contract to meet certain obligations or otherwise face certain defined consequences such as lawsuits for damages, etc. A contract may be one that binds parties to certain obligations of confidence—such contracts are often called “non-disclosure agreements.” Other transactions include inter parties litigations such as dispute in the context of a lawsuit between a plaintiff (a complaining party to a transaction) and a defendant (the party to whom a complaint is directed and who must answer a plaintiffs allegations which give rise to a lawsuit), arbitrations in which parties to a transaction may agree to be bound by an arbitrator's rulings as to the rights of contracting parties (e.g., as in the case of labor disputes and the like); settlement negotiations in which parties to a transaction may work directly with each other or otherwise involve negotiators, arbitrators, and mediators to help them reach settlement of a disputes; and ex parte litigation and processes such as in the case of transactions involving public and private disputes with organizations such as in the case of claims for social security benefits raised before the U.S. Government Social Security Administration and credit card charge disputes directly raised to one's credit card company. It is important to note that the term “transaction” is an inclusive one in the sense that events occurring in everyday interactions between people may now be processed within the systems provided by the present invention. Moreover, a transaction in the context of the present invention may be recursive in that a transaction may include transactions which include transactions and so on, or, a transaction may spawn additional autonomous transactions. For example, a transaction such as a lawsuit may include subordinate transactions such as motions which occur during the disposition of the lawsuit, or a credit card dispute may spawn an additional transaction in the form of a lawsuit. And, despite the fact that the present invention may be utilized to facilitate efficient and effective disposition of a whole transaction such as a whole lawsuit, the present invention does not require complete processing to deliver its benefits; instead, a group of parties involved in a transaction (term: “Transaction Party”—defined below) may agree to access a service provided in accordance with the present invention to facilitate disposition of only a part of a transaction (e.g., a subordinate or, possibly, collateral transaction). Accordingly, it should be readily understood that a transaction may include, but certainly are not limited to, leasing transactions, contract type transactions, franchising transactions, licensing transactions, sales transactions, real estate transactions, Uniform Commercial Code (UCC) related transactions, non-disclosure agreement transactions, and all other interactions between people that require resolution and other similar management.

The term “Transaction Party” means any party including, but not limited to, individuals, organizations, public and private agencies and institutions, governmental organizations, Courts of law, etc. A transaction party may be a party to a lawsuit or be an entity responsible for providing an ancillary services such as a court reporting service in the context of a transaction such as during a lawsuit or other inter parties proceeding which is to be processed, at least in part, within an access controlled environment provided in accordance with the present invention. Transaction parties may or may not be actual, real parties in interest as that term is used in legal contexts; instead, a transaction party may be a Judge's clerk who is responsible for acting on behalf of the Judge in interacting with other transaction parties to resolve, for example, an online based motion.

The term “Access Controlled Environment” means an environment provided and operated within a data processing system or environment in which transaction parties communicate to resolve or otherwise dispose a transaction, engage in contract management functions, etc. An access controlled environment is one that exists as a state within a data processing system or environment such as within a service facility in accordance with the present invention. Transaction parties may safely and securely exchange information and data with other transaction parties within an access controlled environment.

The term “Service Facility” means an automatic data processing system and environment such as one that includes one or more automatic data and computing systems which has been configured in accordance with the present invention to facilitate transaction processing and disposition within an accessed controlled environment via a global network such as the Internet. Furthermore, such a service facility is configured to permit creation and management of contractual relationships and corresponding contracts online within an access controlled environment.

The term “online” means operations and processes that occur via a network communications link. Although the term “online” includes operations occurring via the Internet and WWW, “online” is not so limited. Instead, a process that can be carried out online in accordance with the present invention may be one that is performed completely outside of a publicly accessible network (e.g., the Internet and WWW), such as within an organization or among dedicated networks operating for the benefit of a particular group of organizations.

The terms “Master Transactions Agreement” and “MTA” refer to legally binding and enforceable agreements such as subordinate contracts which may be entered into between transaction parties. An MTA may contain a legally enforceable provision stating that any contract seeking to bind a transaction party A, for example, in its relationship with transaction party B shall be void and/or voidable at the option of transaction party A unless said contract is contained within a specified database which is to be processed online within an access controlled environment. The MTA can also optionally provide that omitted, subordinate contracts are void or voidable at the option of a transaction party, only with the mutual assent of bound transaction parties, etc. In the drawing figures as discussed below, the symbol “K” appears to indicate the existence of a contract and contractual relationship; “K” often is used by lawyers and other practitioners to indicate the same.

The description that follows is broken down into two primary sections: The first section is directed to the structural aspects of the present invention and outlines the structural features of the present invention that are used within an automatic data processing environment such as one that is coupled to the Internet and WWW to facilitate transaction processing and disposition online within an access controlled environment. The second section is directed to the operational aspects of the present invention that are used to facilitate such transaction processing and disposition.

### Structural Aspects Of The Present Invention

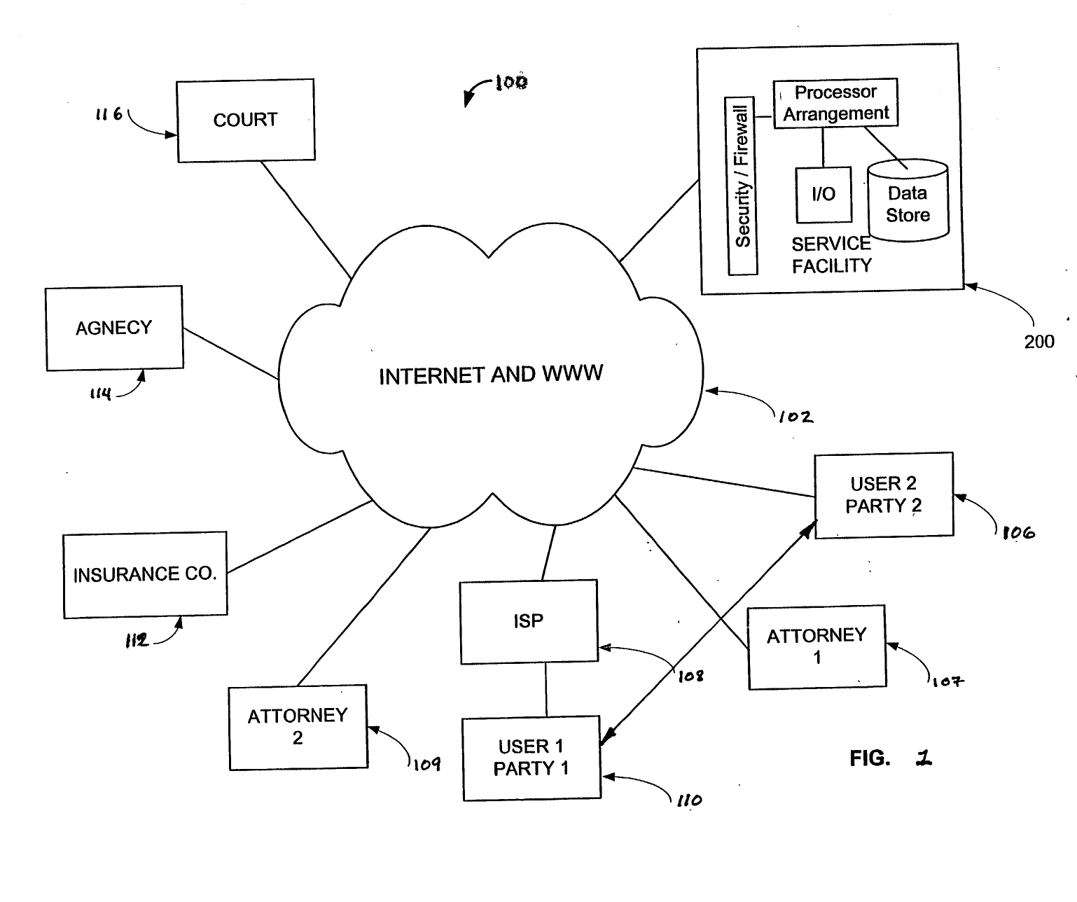

Referring now to FIG. 1, depicted therein is a system diagram that illustrates a connected, network based data processing environment or system 100 in which service facility 200 operates in accordance with a preferred embodiment of the present invention to facilitate transaction processing and disposition, contraction creation and management, etc. within an accessed controlled environment provided by the service facility. In particular, in FIG. 1, system 100 includes a network data processing environment such as the Internet and WWW 102, service facility 200, user2 106, attorney1 107, an Internet service provider (ISP) 108, user1 310, attorney2 109, an insurance company 112, an agency 114, and another transaction party such as a Court 116 or other agency or decision making authority. The structures shown within system 100 may be interconnected via the Internet such as via modern telecommunications links, wireless links, and any other known and contemplated communications infrastructures. Such communications links and along with networking structures to facilitate the Internet and WWW will be readily understood by those skilled in the art. In particular, the open standards protocols used to facilitate network based communications such as TCP/IP and content rendering languages such as HTML, dynamic HTML (DHTML), JSP, JAVA, Javascript, Java beans, WAP (and other wireless technologies and protocols), along with security protocols such as secure socket layer (SSL) and other similar and like technical standards and technologies will be readily understood by those skilled in the art.

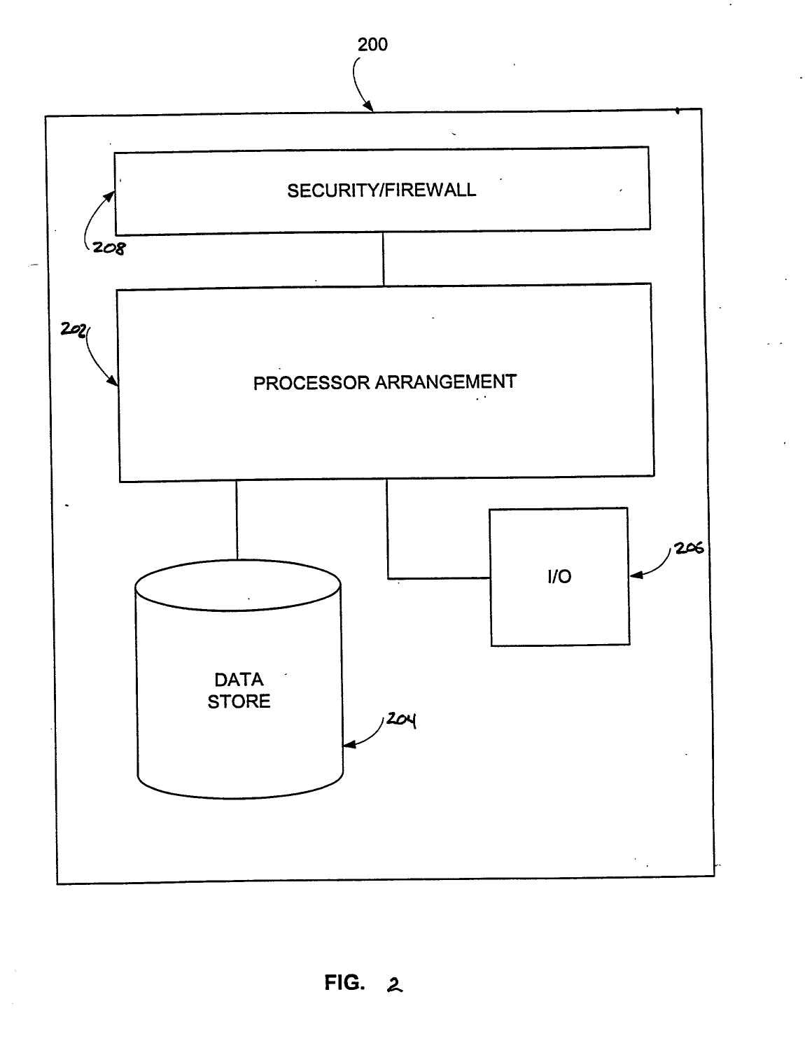

As shown within system 100, service facility 200 has an exemplary structure including a processor arrangement, input and output (I/O) facilities, a data store, and security and fire wall structures and technologies. Those skilled in the art will immediately understand the structure of service facility 200 especially in view of the structures shown in greater detail in FIG. 2 as discussed below. Service facility 200 is configured within system 100 to provide and maintain access controlled environments and to facilitate the interaction of transaction parties in the context of disposing of transactions, the creation and management of contractual relationships and corresponding contracts, etc. in accordance with the present invention.

More particularly, service facility 200 is a web-enabled server system that has been configured in accordance with the present invention to permit web access to an access controlled environment which exists as a state within service facility 200. Because service facility 200 is Internet accessible, it uses firewall technology and other similar and like technologies to avoid and secure against unwanted access and intrusion by hackers and other unauthorized personnel. A major security component of service facility is anti-virus security to ensure that transaction data such as contract related data and information stored within a data storage facility is protected from virus type intrusions. A preferred web-enabled, Internet ready platform suitable for instantiation of a service facility 200 includes data processing facilities such as those manufactured and marketed by iPlantet and SUN MICROSYSTEMS and runs the SUN SOLARIS operating system, ORACLE including the ORACLE APPLICATION SERVER, ORACLE DATBASE SERVER, access control facilities such as those implemented to utilized PKI and other security schemes compatible with RSA security processes and schemes. Additionally, service facility 200 will include firewalls, virus detection and processing systems and facilities, etc.

In system 100, user2 106, attorney1 107, an Internet service provider (ISP) 108, user1 110, attorney2 109, an insurance company 112, an agency 114, and another transaction party such as a Court 116 or other agency or decision making authority, or other agency or decision making authority, represent user systems and/or external systems that are used by transaction parties in order to access service facility 200 in order to facilitate the dispositions of a transaction, creation and management of contractual relationships and corresponding contracts, etc. Such user systems or external systems may be, for example, conventional PC's executing a web browser with access to the Internet and WWW 102, wireless devices, personal digital assistants (PDAs), phones, NEXTEL type phones, and other similar and like communications and data processing devices, and/or other computer arrangements (e.g., web server facilities, application servers, etc.). Furthermore, such user systems and external systems may include back office systems, management systems, content retrieval systems, and other related data systems.

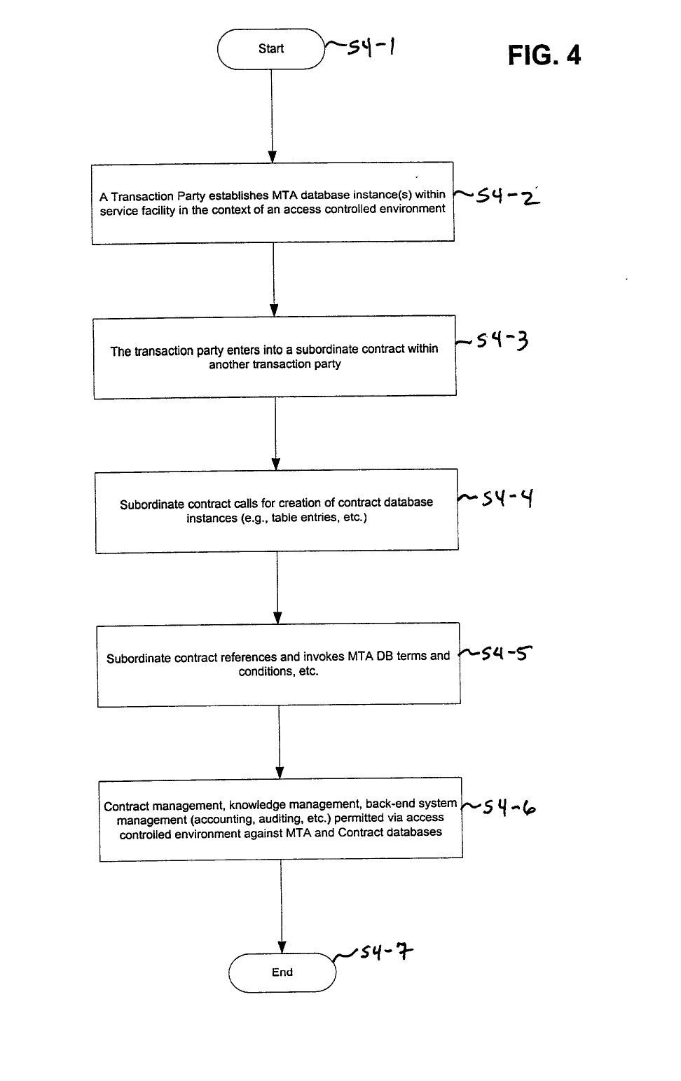

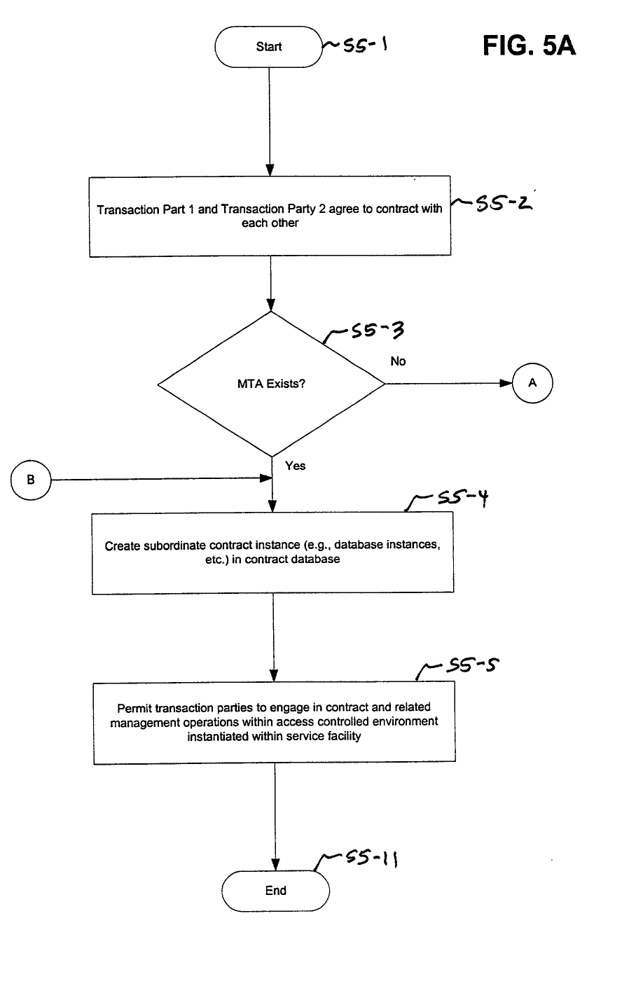

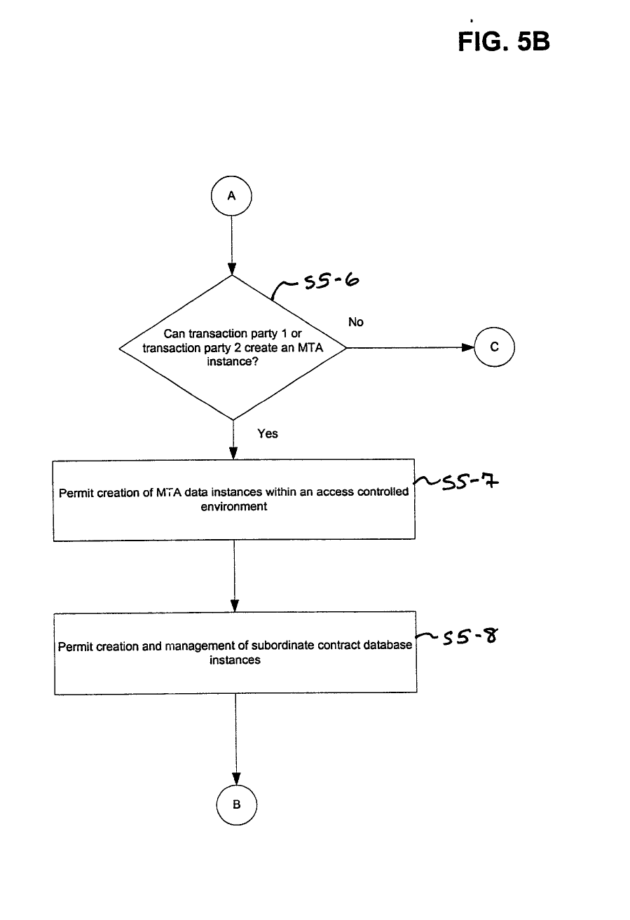

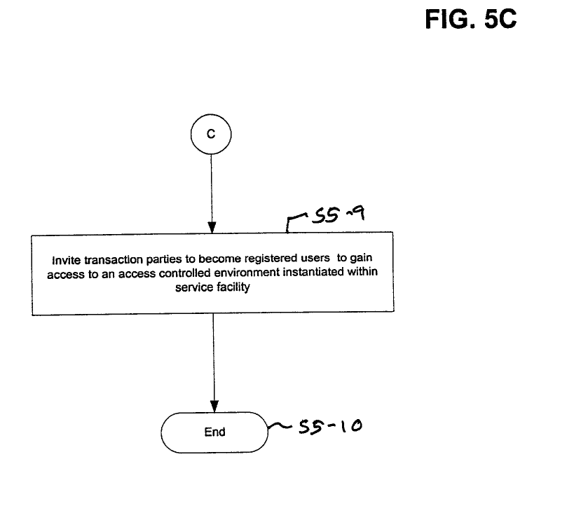

It is important to note that although system 100 includes one service facility, actual implementation of a networked infrastructure which is Internet and WWW accessible may be outfitted with more than one such service facility. Moreover, although service facility is shown as a separate component, such illustration is not intended to limit the scope of the present invention. To the contrary, those skilled in the art will readily appreciate that a distributed architecture could be used for such an accessible infrastructure. And, it should also be understood that a service facility of the type contemplated by the present invention may be implemented within a particular organization such as within a non-public network; in such a case, service facility 200 may be configured with the same open-standards based technologies and computer software to provide the same level of functionality as described below with regard to FIGS. 4-5C to facilitate transaction processing and disposition, creation and management of contractual relationships and corresponding contracts, etc. in a networked environment and/or in some other network type environment such as within a peer-to-peer network environment.

Referring now to FIG. 2, depicted therein is detailed block diagram of service facility 200 to clearly illustrate the data processing system nature of such a facility. In particular, service facility 200 includes a processor arrangement 202 including one or more automatic data processing systems which may be coupled together and/or otherwise linked to facilitate a data processing engine to operate in accordance with programmatic structures and the like and the type that are illustrated in FIGS. 4-5C. Coupled to processor arrangement 202 are I/O facilities 206. Such I/O facilities 206 are configured to support network communications such as those carried out via defined protocols including, but not limited to, TCP/IP.

Also coupled to processor arrangement 202 is data store 204. Data store 204 is configured to support database management operations and to provide (along with appropriate database management software such as ORACLE V.x which is manufactured and marketed by ORACLE CORPORATION) the database management facility within service facility 200. The operations of such a database management facility are discussed in detailed below with regard to the flow charts identified in FIGS. 4 through 5C.

Also coupled to processor arrangement 202 are security and firewall structures and facilities 208 to prevent against unauthorized access to service facility 200. Such facilities enable service facility 200 to maintain a particular level of security to avoid unwanted access to data and, ultimately, transaction data within access controlled environments operated as states within service facility 200. Firewall technology and other security mechanisms to prevent unwanted access to controlled accessed environments may be hardware, software, or a combination thereof and will be readily understood by those skilled in the art. Accordingly, security and firewall facilities 208 will permit system designers and implementers to implement systems and operations that permit users with valid ID codes, biometric attributes (finger print qualities, etc.), etc. to either be permitted to access controlled environments or to be denied such access. Such security facilities may used by implementing RSA ACE Server and token technology, for example. Details related to the nature of access controlled environments that may be instantiated within service facility 200 are laid out in co-pending U.S. Pat. Application Ser. No. 09/XXX,XXX filed on Nov. 22, 2000, which application is entitled “SYSTEM AND METHOD FOR FACILITATING TRANSACTION PROCESSING AND DISPOSITION WITHIN AN ACCESS CONTROLLED ENVIRONMENT VIA A GLOBAL NETWORK SUCH AS THE INTERNET,” and which has been incorporated herein by reference.

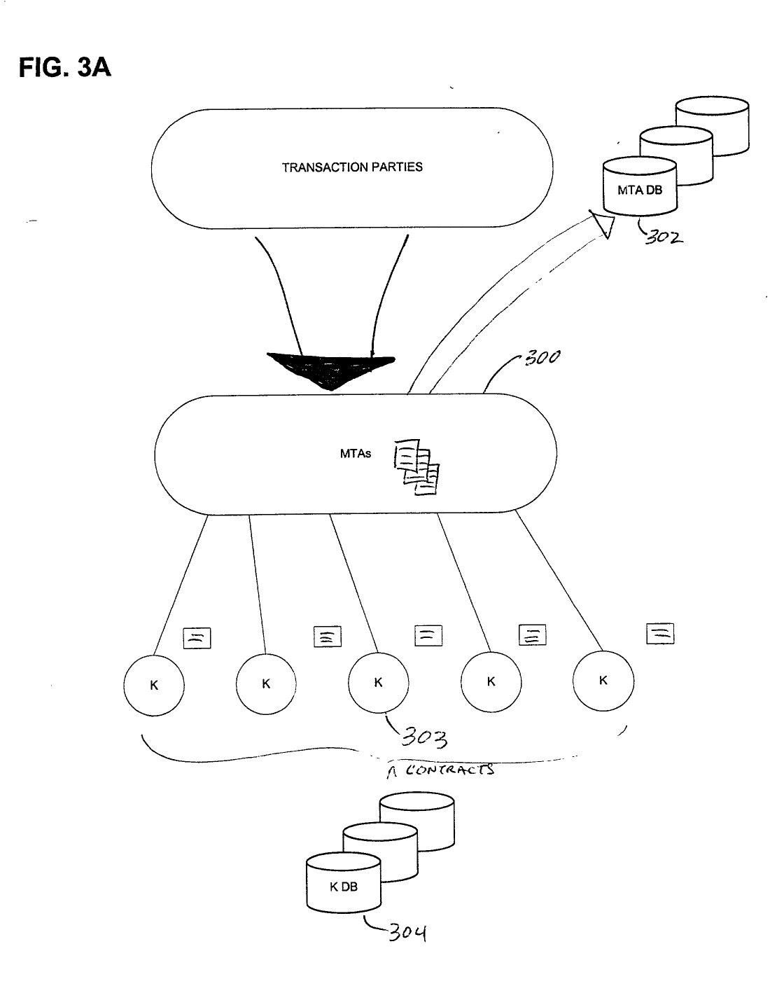

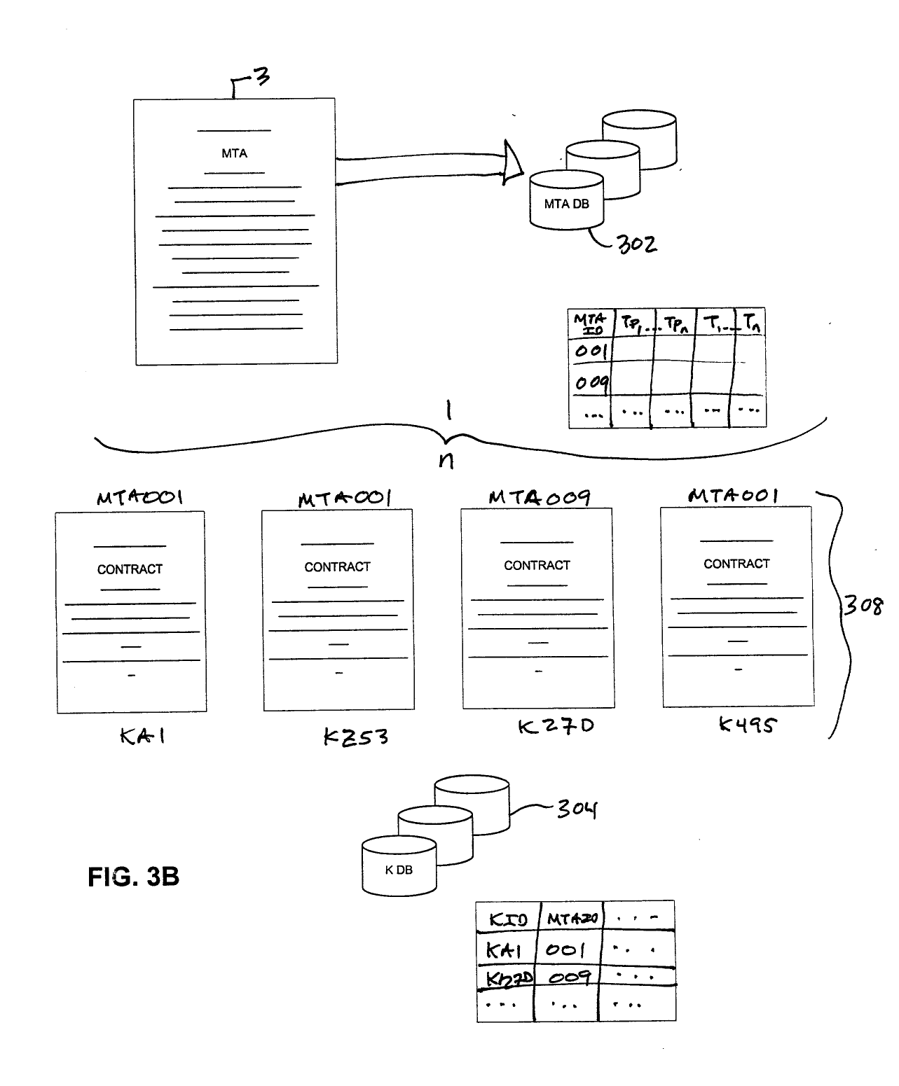

Referring now to FIG. 3A, depicted therein is a logical system diagram that illustrates the Master Transactions Agreement(s) (“MTAs”) and corresponding subordinate contracts and contractual relationships that are enforceable between transaction parties in accordance with a preferred embodiment of the present invention. In particular, transaction parties who obtain access to a controlled access environment such as one facilitated by service facility 200 (FIG. 1) may now engage in creating and managing their contracts and agreements with other transaction parties in a controlled access environment provided by the present invention. Transaction parties can cause creation of MTAs and subordinate contracts (contractual relationships) by causing creation of an MTA instance within an appropriate data store 300 for MTAs within service facility 200. Such a data store may be stored in an MTA database 302. Subordinate contracts 303 are related to MTAs within service facility 200 and MTA database 302. Data related to such subordinate contracts 303 are stored in contract database(s) 304. The storage, retrieval, and management of data within MTA database 302 and contract database 304 preferably is carried out using relational database techniques and technologies such as those facilitated through use of a relational database management system similar or like ORACLE V.x which is manufactured and marketed by ORACLE CORPORATION. ORACLE is a trademark and/or registered trademark of ORACLE CORPORATION.

Accordingly, those skilled in the art of database design, should readily understand that a 1:n relationship may exist between a given MTA and its subordinate contracts. Such a relationship is not required-instead, other data relationships may be instituted such as several MTAs affecting a single (or more than one) subordinate contract. Accordingly, those skilled in the art should immediately understand that many data modeling choices may be made in implementing the present invention.

By way of example only, an MTA may be created between transaction party A and transaction party B, or any larger number of parties. Such an MTA contains a legally enforceable provision stating that any subordinate contract seeking to bind transaction party A in its relationship with transaction party B shall be void and/or voidable at the option of transaction party A unless said contract is contained within a specified database or repository maintained within and/or by service facility 200 (FIG. 1). The MTA can also optionally provide that omitted contracts are void or voidable at the option of transaction party B, or only with the mutual assent of transaction parties A and B.

Transaction party A and Transaction party B can then each maintain a database of counterparties with which it has entered into MTAs (the “MTA Database”) as well as a database of contracts that are subject or subordinate to the MTAs (the “Contract Database”). These databases can be maintained within a single database, or within multiple interconnected or interdependent databases (e.g., a distributed architecture). A relational database scheme is preferred although not required.

The MTA can be defined with various degrees of inclusion. In its most expansive form, the MTA would apply to all contracts, past and future, between transaction parties A and B, without regard to the subject matter of the agreements. Such a broadly defined MTA could, however, generate many difficulties. For example, if an otherwise binding and effective contract was executed prior to the effective date of the MTA, and if, through oversight, the contract was inadvertently excluded from the database specified by the MTA, then the contract could be voided even though that was not the intention of the parties. Accordingly, some transaction parties might find it desirable for the MTA to specify that it govern only contracts entered into after a specific date, or contracts that relate to specific forms of goods and services, such as real estate leases or software licenses, where the parties are sufficiently confident that they can attain completeness in their records.

The MTA can further be constructed to contain provisions that would expand the terms and conditions of contracts that are silent as to matters that are actually specified or otherwise contemplated in the MTA. For example, the MTA can specify choice of law provisions (e.g., what state's law shall apply to a given dispute), choice of forum provisions (e.g., the choice of a court, etc.), arbitration provisions, notice provisions, etc. that would be effective if a contract that is subject to the MTA is silent as to any of those matters. Alternatively, the MTA can be structured so as to contain provisions that would apply notwithstanding the existence of provisions to the contrary in any other contract subject to the MTA. Such a mechanism would allow a transaction party to assure compliance with an enterprise-wide contractual policy notwithstanding terms to the contrary that might be negotiated in any past and/or future negotiations relating to a specific contract.

The MTA can further provide for a “cure process” designed to address the potential invalidity of contracts that have inadvertently been omitted from the database. For example, in the event a contract has been omitted from the Contract Database the cure provisions of the MTA can provide for terms and conditions under which the contract can still be enforceable. Cure provisions may, for example, require concurrence of transaction party A's auditors that the contract is immaterial to transaction party A's financial situation and that recognition of the contract would not require any restatement or amendment to current or past financial statements.

The adoption of an MTA program, in order to be effective, would ideally, but not necessarily, be integrated with a variety of administrative and financial functions within the enterprise in order to assure that: (1) all counterparties who should be bound by MTAs are so bound; and (2) all contracts that should be submitted to the Contract Database are so submitted. For example, in order to assure that all suppliers and customers that should be subject to an MTA are so bound, an MTA program can be integrated with the corporation's accounts receivable and accounts payable functions in order to flag cash flows or other relationships with counterparties according to whether an MTA is in place. If cash flows are identified to or from entities that are not covered by MTAs, then corporate officers can inquire as to the nature of those flows and consider requiring that the counterparties enter into MTAs.

A desirable feature of the Contract Database that would be generated pursuant to the operation of the MTA is that it could be partially shared among the counterparties to the MTA. Thus, if the database contains all contractual relationships binding transaction party A with transaction party B as well as with many other counterparties, transaction party B could have access only to those contracts that bind transaction party B, while transaction party A can have access to the entire database. This shared access feature would allow both parties A and B to have assurance as to the full nature of the agreements binding the parties, without providing inappropriate access to either countertransaction party. Indeed, such joint access could be viewed as an essential feature of the Contract Database because, absent joint access, transaction party B could have a concern that not all of the agreements binding it and Transaction party A are properly stored in the Contract Database.

The existence of the MTA also provides a valuable mechanism for assuring the integrity of the financial audit process. Audits can be called into question, and enterprises can be required to restate their financial statements in a manner that can lead to expensive litigation, because of the existence of side-letters that are concealed from auditors and that grant counterparties return rights, or specify other material terms that deviate from the body of the contract. If, however, an enterprise has an MTA with a countertransaction party then the possibility of an enforceable hidden side-letter is eliminated, at least with respect to the subject matter that is governed by the MTA. The quality of the audit process is thereby greatly enhanced.

Indeed, in certain situations, contracts may be subject to repudiation if they are not sufficiently apparent on the books and records of an enterprise. The operation of an effective MTA would eliminate such repudiation risks with respect to all matters required to be entered into the database.

The process of adopting and enforcing an MTA has further advantage because of the synergies and opportunities for cost sharing efficiencies that can be generated by such programs. Consider the example of transaction party A who contracts only with parties B and C. Transaction parties B and C in the example also contract with each other, as well as Parties D, E, F, G, etc. If Transaction party A implements an MTA program with B and C, then parties B and C will be able to obtain a material portion of an MTA program's benefits through shared access to transaction party A's database even if they do not adopt an MTA program of their own. The marginal cost to parties B and C of adopting a full MTA program would then be reduced by the fact that each of transaction party B and transaction party C would only have to add contracts between parties B and C to complete a material portion of their own MTA database. Each of parties B and C could then expand their database by adding contracts with other counterparties, D, E, F, G, etc. Accordingly, the use of an MTA generates significant potential economies of scale as a result of network effects that are inherent to contract relationships.

The efficiencies of such an arrangement are further enhanced as transaction party's MTA is maintained at a shared database site operated by a trusted third transaction party where each contract would be entered once and where access would be strictly limited to the parties to each contract. Alternatively, each transaction party can maintain its own distinct database and use a common trusted third transaction party administrator (e.g., service facility 200) to assure that contract databases are consistent across counterparties. In this situation, the trusted third transaction party would assured that transaction party A's database of contracts with transaction party B is identical with transaction party B's database of contracts with transaction party A.

A further and potentially distinct application of an MTA is to contracts that contain dynamic terms and conditions. A term or condition of a contract is considered dynamic for present purposes if its purpose or effect at some point in the future may differ from its purpose or effect at the time that the contract is entered into or becomes effective. One common example of a dynamic term or condition is a “most favored nation” (MFN) clause. If a contract contains a MFN clause relating to the price at which a good will be sold, then the price that appears on the face of the contract may be subject to a substantial reduction because of a later contract that triggers the MFN clause.

A second example of a dynamic term or condition is a pricing formula that depends on future commodity prices, interest rates, or inflation rates.

In both examples substantial contract compliance issues can arise if there is no shared database involving the parties so that each individual agreement. In particular, in the case of a contract containing an MFN clause between Transaction party A and transaction party B, unless transaction party B or a person acting on transaction party B's behalf, has access to all other contracts entered into by transaction party A relating to the subject matter of that contract, transaction party B will be unable to test or have any assurance that some later agreement between parties A and C has not triggered a MFN obligation owed to transaction party B. Because transaction party A will have legitimate reason not to allow transaction party B to have access to all contracts that might relate to the MFN at issue, or to provisions in relevant contracts with third parties that are unrelated to the MFN, parties A and B might agree to retain a trusted and independent third transaction party to monitor and identify contracts entered into the Contract Database that might trigger the MFN obligation.

The case of a dynamically adjusted pricing formula raises a simple, though not insubstantial, contract management and compliance issue that can be addressed through the application of MTAs. That is, appropriate logic to alert transaction parties of MFN triggers, etc. can now be implemented across a multitude of contracts without requiring conventional manual scanning techniques, thus negating litigation and liabilities resulting from unintentional breaches.

The databases generated by the MTA can also provide a valuable foundation for the application of a broad range of knowledge management and process management tools. Given the existence of a Contract Database, a broad variety of knowledge management tools can be applied in order to extract additional value from that database for the enterprise. In particular, a variety of techniques, such as XML tagging and intelligent search, can be used to extract relevant data from the full text of the contracts entered into the database. The extracted information may, for example, relate to the expiration date of the agreement, the size of the contract, and the name of the countertransaction party. In many situations, however, the four corners of the contract (the complete binding agreement) will not contain all the information that a transaction party would wish to know regarding the agreement. For example, the contract may have been negotiated by a particular marketing team, or may contain specific concessions that were offered for reasons not apparent on the face of the document. To capture this additional information, the Contract Database can be coupled with a series of additional questionnaires or other data entry tools designed to extract and collect valuable information not contained in the document.

The knowledge management system would then, for example, be able to search across financing agreements of all types to identify all relations that a transaction party might have with a specific bank or other countertransaction party. The accumulation of such information could provide valuable bargaining leverage across a range of transactions. The knowledge management system could also allow mangers to track the expiration date of contracts and to route expiring contracts by size or by the name or nature of the countertransaction party. This facility could enhance a sales departments' ability to cause renewal of particularly valuable contracts.

The existence of a Contract Database which may or may not be supplemented by information, not apparent on the four corners of the document, would also allow for the application of a broad range of process management tools. For example, on-line negotiation and electronic signatures can occur in the Contract Database itself, thereby assuring prompt compliance with the MTA and allowing management to track the progress of individual negotiations down to real time observation of the evaluation of specific terms. The Contract Database can be further expanded in this regard to allow for the retention of non-binding prior drafts of agreements to provide for an agreed-upon history of the negotiations, if the parties deem that desirable.

Referring now to FIG. 3B, depicted therein is a schematic database diagram that illustrates the relationships that may exist between an MTA and subordinate contractual relationships that are created and managed within access controlled environments in accordance with a preferred embodiment of the present invention. FIG. 3B is intended to further illustrates the relationships discussed above with regard to FIG. 3A.

In particular, an MTA 3 such as a master supply agreement, or a master leasing agreement, a master real estate sales contract, etc. contains terms and conditions which parties negotiate and agree to like any other agreement. Data regarding MTA 3 is stored in an MTA database 302 and, in particular, in a data structure similar or like a table driven data structure 303. Data structure 303 contains rows and columns containing data such as MTA Ids 305, identifications of bound transaction parties, and term specifiers. Such term specifiers are similar or like those discussed above with regard to FIG. 3A. The storage of data in such a data structure will be immediately understood by those skilled in the art of database management system design and implementation.

Also in FIG. 3B are shown subordinate contracts 308. Such contracts may be any form of agreement and correspond to at least one MTA such as MTA 3. Data regarding such subordinate contracts 308 are stored in contract “K” database 304. As with data structure 303 for MTAs, the contract database may be arranged within table driven data structures 306. Within table 306, data regarding a multitude of subordinate contracts may be stored, such as contract Ids (K-lds) 307, MTA Ids, and such other information as may be required or desired depending on particular design attributes and preferences. Those skilled in the art will readily appreciate that records within contract database 304 are related, for example, to records within MTA database 302 by way of MTA Ids, etc. For example, data base entries (which may include multiple records spanning multiple data tables, etc.) for a particular subordinate contract like or similar to contract KA1 may be subordinate to MTA 001 (the first line in table 303). As will be readily appreciated from inspection of FIG. 3B, each MTA may be related to a one or more subordinate contracts (and vice versa), hence what is shown is a 1 to many relationship (a.k.a. a 1:n data relationship). Alternate arrangements such as subordinate contracts having several related and corresponding MTA agreements (e.g., an M:n relationship, etc.).

Although, relational database constructs are preferred, other database management schemes may be used such as hierarchical schemes, etc.

The creation of MTAs and subordinate contracts and the relationships that go along with such contracts, may now be managed within the context of an access controlled environment facilitated via operation of service facility 200. Users can access service facility 200 such as via the Internet and manage their contract affairs centrally and in a secure online fashion. Accordingly, entities such as larger corporate organizations may now outsource the burdensome task of contract management to service facility 200 that will care for and manage the critical data associated with a multitude of related contract matters and relationships.

### Operational Aspects Of The Present Invention

The structures depicted in FIGS. 1 through 3B are configured to operate together to provide systems and methods for facilitating creation and management of contractual relationships and corresponding contracts such those which now may be accessible via a global network such as the Internet and WWW. Accordingly, reference is now made to FIGS. 4 through 5C to illustrate the operational aspects of the present invention.

With particular, reference to FIG. 4, depicted therein is a generalized flowchart that illustrates the exemplary operations carried out within the system shown in FIG. 1 to facilitate creation and management of contractual relationships and corresponding contracts in accordance with a preferred embodiment of the present invention. In particular, processing and operations start at step S4-1 and immediately proceed to step S4-2. At step S4-2, a transaction party may establish an MTA within an access controlled environment provided within a service facility 200 (FIG. 1). Accordingly, database instances in the MTA database will be created (FIG. 3B).

Next, at step S4-3, the transaction party will enter into a subordinate contract with another transaction party. Such a subordinate contract will be subject to the terms and conditions specified in MTA, which are stored within the MTA database for that particular MTA.

Next, at step S4-4, the subordinate contract will call for creation of appropriate database instances within the contract database.

Next, at step S4-5, the subordinate contract instances will invoke the MTA database requirements and terms and conditions as specified above.

Next, at step S4-6, the transaction parties may engage in contract management operations regarding subordinate contracts permitted via the access control environment. Such contract management may cause appropriate alerts and the like which are based on terms and conditions specified in the MTA and the subordinate contracts themselves. For example, if an MTA and/or a corresponding subordinate contract contain clauses related to most favored nation (MFN) status, an alert (e.g., an email, wireless page/message, etc.) may be sent to a transaction party to notify that party that a new subordinate contract, for example, may trigger the terms and conditions of the earlier instituted MFN or other similar or like clause. Accordingly, the present invention now enables contract management to be more effectively achieved through automatic notification related to individualized contract terms and conditions. Such automatic monitoring for and notification of contracts within a large corporate environment, for example, will help to negate liability for unintentional and, often, unavoidable, innocent contract breaches. The present invention facilitates greater control not just over contracts (MTAs and subordinate contracts), but also greater control and management of contractual relationships among contracting parties.

Processing and Operations Ends at Step S4-7.

Referring now to FIGS. 5A through 5C, depicted therein is a detailed flowchart that illustrates the operations that are carried out to facilitate creation and management of contractual relationships and corresponding contracts in accordance the preferred embodiments of the present invention. In particular, processing and operations start at step S5-1 and immediately proceed to step S5-2. At step S5-2, a transaction party one and a transaction party two agree to contract with each other.

Next, at step S5-3, a determination will be made as to whether an MTA database record instance already exists within an MTA database as accessed through an access controlled environment provided by service facility 200 (FIG. 1). If such an MTA exists, processing and operations will continue at step S5-4.

At step S5-4, a subordinate contract database instance will be created in the contract database as illustrated in FIGS. 3A and 3B.

Next, at step S5-5, the transaction parties will be permitted to engage in contract operations and management within an access controlled environment as provided within service facility 200.

Thereafter, processing and operations ends at step S5-11.

If the determination made at step S5-3 is negative, processing and operations will continue at the top of FIG. 5B and, in particular, at step S5-6.

At step S5-6, a determination will be made as to whether party 1 or party 2 can create the MTA or will actually create the MTA. If either party can create the MTA, processing and operations continue at step S5-7.

At step S5-7, processes and operations will permit creation of MTA database instance(s) within MTA database as shown in FIGS. 3A and 3B.

Next, the transaction parties will be permitted to create a subordinate contract and appropriate contract database instances at step S5-8.

Thereafter, processing and operations continues back to step S5-4 and shown in FIG. 5A as discussed above.

If the determination made at step S5-6 is negative, processing and operations continue at the top of FIG. 5C and, in particular, at step S5-9.

In particular, at step S5-9, one or more of the transaction parties will be invited to become registered users within an accessed controlled environment provided within service facility 200 so that one or more transaction parties then thereafter create an appropriate MTA and subordinate contract database instances within the MTA and contract databases, respectively, as shown within FIGS. 3A and 3B.

Thereafter, processing and operations ends step S5-10.

Thus, having fully described the present invention by way of example with reference to the attached drawing figures, it will be readily appreciated that many changes and modifications may be made to the invention and to any of the exemplary embodiments shown and/or described herein without departing from the spirit or scope of the invention which is defined in the appended claims.

What is claimed is:

1. A system for facilitating creation and management of contractual relationships online within an access controlled environment, comprising:
a service facility configured to establish access controlled environments, said access controlled environments permitting users to engage in secure online operations relative to binding contracts; and
a data storage facility coupled to said service facility permitting said users to store and access data related to said binding contracts within said access controlled environments, said data storage facility including a master transaction agreement database and a contract database, said master transaction agreement database storing data related to master transaction agreements and said contract database storing data related to contracts which are subordinate to at least one master transaction agreement.

2. The system according to claim 1, wherein said service facility includes a security facility preventing unauthorized access to said service facility and said access controlled environments.

3. The system according to claim 1, wherein said service facility is accessible via the Internet.

4. The system according to claim 1, wherein said data storage facility incorporates a relational database management system.

5. The system according to claim 1, wherein said data master transaction agreement database permits storage of contractual terms that globally effect at least one corresponding subordinate contract.

6. The system according to claim 1, wherein said master transaction agreement database permits storage of enforceability terms that define conditions of enforceability for at least one subordinate contract.

7. The system according to claim 1, wherein said master transaction agreement database includes table-based data structures.

8. The system according to claim 1, wherein said contract database permits storage of a key reference to a master transactions agreement for which data is stored in said master transaction agreement database.

9. The system according to claim 1, wherein said master transaction database and said contract database may be queried by a database management system to derive a management report.

10. The system according to claim 1, wherein said data storage facility automatically notifies at least one user of said users based on terms contained in at least one master transactions agreement.

11. The system according to claim 1, wherein said data storage facility automatically notifies at least one user of said users based on terms contained in at least one subordinate contract.

12. A method for facilitating creation and management of contractual relationships online within an access controlled environment, comprising the steps of:
at a service facility configured to establish access controlled environments, permitting users to engage in secure online operations relative to binding contracts within said access controlled environments;
at a data storage facility coupled to said service facility, permitting said users to store and access data related to said binding contracts within said access controlled environments; and
maintaining within said data storage facility a master transaction agreement database and a contract database, said master transaction agreement database storing data related to master transaction agreements and said contract database storing data related to contracts which are subordinate to at least one master transaction agreement.

13. The method according to claim 10, further comprising the step of preventing unauthorized access to said service facility and said access controlled environments.

14. The method according to claim 10, wherein said permitting step permits users to access said service facility via the Internet.

15. The method according to claim 10, wherein said data storage facility incorporates a relational database management system, and said maintaining stores said data related to said master transaction agreements and said data related to contracts which are subordinate to at least one master transaction agreement in related data structures.

16. The method according to claim 10, wherein said data master transaction agreement database permits storage of contractual terms that globally effect at least one corresponding subordinate contract.

17. The method according to claim 10, wherein said master transaction agreement database permits storage of enforceability terms that define conditions of enforceability for at least one subordinate contract.

18. The method according to claim 10, wherein said master transaction agreement database includes table-based data structures.

19. The method according to claim 10, wherein said contract database permits storage of a key reference to a master transactions agreement for which data is stored in said master transaction agreement database.

20. The method according to claim 10, wherein said master transaction database and said contract database may be queried by a database management system to derive a management report.

21. The method according to claim 10, further comprising the step of automatically notifying at least one user of said users based on terms contained in at least one master transactions agreement.

22. The method according to claim 10, further comprising the step of automatically notifying at least one user of said users based on terms contained in at least one subordinate contract.
